(19) United States
(12) Patent Application Publication
(10) Pub. No.: US 2008/0025876 A1
(43) Pub. Date: Jan. 31, 2008

(54) Vapor sensor materials having polymer-grafted conductive particles

(76) Inventor: Praveen C. Ramamurthy, Mansfield, OH (US)

Correspondence Address: HARNESS, DICKEY & PIERCE, P.L.C., P.O. BOX 828, BLOOMFIELD HILLS, MI, 48303, US

(21) Appl. No.: 11/493,323

(22) Filed: Jul. 26, 2006

(51) Int. Cl. G01N 30/96

(52) U.S. Cl. 422/88; 422/82.02

(57) ABSTRACT

A composition for sensor films is provided that detects chemical analytes within sensors, such as polymer-absorption chemiresistors (i.e., conductometric sensors). The disclosure provides robust sensor film compositions that have low resistance, high conductivity, and greater temperature stability and sensitivity to chemical analytes. Methods of making these sensor films are also provided. Sensor film compositions include a matrix having a polymer resin and a plurality of conductive particles comprising a polymer-grafted conductive particle. Blends of conductive particles are also contemplated.

### FIELD

The present disclosure relates to sensor films, and more particularly to sensor films that detect vapor analytes.

### BACKGROUND

Detection of specific target analytes, or chemical compounds, is important for many applications, including for example, detecting whether the concentration of analytes exceeds flammability limits. Target analytes are detected by sensors operating according to different detection mechanisms, known in the art. Most sensors employ a sensing component that is physically modified in the presence of specific analytes present in the environment. Thus, a sensor typically comprises a probe that includes both the sensing component and a probe body housing (including terminals for transmitting an output). The terminals are typically coupled to a processor, also part of the sensor, which analyzes the outputs received from the sensor probe to a user interface. Such a user interface typically contains an indicating device which signals a user when concentration values of an analyte have been exceeded.

Many sensors employ a sensing component that is a sensor film. Many sensor films swell, increasing in volume, while in the presence of the analytes. Various sensors available in the art utilize the physical changes in the sensor film to determine concentration of analyte present. Such sensors may include optical sensors, such as fiber optic sensors, where a beam of light is projected through an optical fiber at a sensor film cladding, and physical changes (e.g., refractive index or color) in the film are monitored. Such changes in refractive index occur when analytes are absorbed and change the physical properties of the cladding (including volumetric changes). Other sensors include surface acoustic wave sensors (SAWS), which project ultrasonic waves through the sensor film between transducers, and likewise detect any modifications in the properties of the sensor film (primarily the mass), translating those changes to the concentration of analyte present.

Another type of sensor film is a conductometric sensor, more particularly, a polymer-absorption chemiresistor sensor. A polymer-absorption chemiresistor has a polymer film sensor exposed to a surrounding atmosphere containing target analytes (chemical compounds). An electrical charge is applied across the polymer film. The polymer absorbs target analytes and this results in a volumetric change of the film, and hence the electrical resistance of the film.

Further, conductive particles may be distributed throughout the polymer film to enhance the sensitivity to resistance changes in the material when the volume of the polymer changes. However, any sensor film that relies upon physical changes resulting from absorption of the chemical analytes (i.e., volume, mass, refractive index, and resistance) is generally also sensitive to volumetric changes dependent on temperature. Further, enhancing the sensitivity to chemical analytes is desirable. Additionally, there are many applications where only a low amount of current is available and require low resistance sensors. There is a need for a low resistance sensor film composition that enhances sensitivity to desired chemical analytes, while further increasing its stability during temperature fluctuations.

### SUMMARY

In one aspect, various embodiments of the present disclosure provide a conductometric sensor film for detecting chemical analytes. In certain embodiments, the sensor film comprises a polymer matrix comprising a crosslinked polymer resin and a plurality of particles comprising a plurality of polymer-grafted conductive particles homogeneously distributed within the matrix. When the sensor film is in the presence of one or more chemical analytes, it exhibits a change in resistance.

In another aspect, various embodiments of the present disclosure provide a low resistance conductometric sensor film for detecting chemical analytes where the film comprises a polymer matrix comprising a crosslinked polymer comprising a siloxane monomer and a plurality of polymer-grafted conductive carbon black particles homogeneously distributed within the matrix. The sensor film exhibits a base resistance that is less than or equal to about 5 kOhms.

In various embodiments of the present disclosure a low resistance conductometric sensor film is provided for detecting chemical analytes comprising a polymer matrix. The matrix comprises a crosslinked polymer comprising siloxane and a plurality of polymer-grafted conductive carbon black particles homogeneously distributed within the matrix. The polymer of the polymer-grafted conductive carbon black particles is electrically conductive and selected from the group consisting of: polyaniline, polypyrrole, polythiophene, and mixtures thereof.

Further areas of applicability of the present disclosure will become apparent from the detailed description provided hereinafter. It should be understood that the detailed description and specific examples, while indicating the various aspects of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of operational principles of an exemplary chemiresistor sensor;

FIG. 2 is a schematic illustration of an exemplary chemiresistor sensor that can be used in accordance with the present disclosure;

FIG. 3 is a cross-sectional view taken along line 3-3 of FIG. 2;

FIG. 4 is a detailed view of an exemplary sensor film region;

FIG. 5 is a schematic illustration of operating principles of a matrix polymer film of a polymer absorption chemiresistor; and

FIG. 6 is a chart showing vapor to temperature ratios based on resistance of sensor films prepared in accordance with certain embodiments of the present disclosure over time.

### DETAILED DESCRIPTION

The following description is merely exemplary in nature and is in no way intended to limit the disclosure, its application, or uses.

The present disclosure contemplates a sensor film having improved temperature stability and sensitivity to analytes. Further, in various embodiments of the present disclosure, the sensor film in the sensor exhibits a relatively low resistance upon exposure to one or more chemical analytes. In accordance with the present disclosure, the sensor films have increased robustness, long-term durability and sustained performance capability.

There are various challenges associated with the development of robust sensor films that have superior sensitivity to one or more chemical analytes, while exhibiting stability to temperature fluctuations, particularly for low resistance applications. In particular, there are challenges associated with the selection of conductive particles for use in the polymer matrix forming the sensor film. Often, it is difficult to stabilize and maintain a homogeneous distribution of such conductive particles due to potential phase separation and migration within the matrix. Preferably sensors are robust and capable of withstanding mechanical shock, vibration, and thermal shock, which includes maintaining a substantially homogeneous distribution of the plurality of conductive particles for long durations of use. Further, certain otherwise desirable conductive particle species may be difficult to process and/or distribute within the matrix.

In accordance with various embodiments of the present disclosure, a conductive polymer matrix comprises a polymer resin and a plurality of polymer-grafted conductive particles. The use of the polymer-grafted conductive particles unexpectedly improves sensitivity to target analytes and reduces sensitivity to variations in temperature, improves conductance and hence lowers resistance of the polymer matrix film in a sensor, and increases stability of the particles in the matrix, thus increasing the long-term durability and performance of the polymer film.

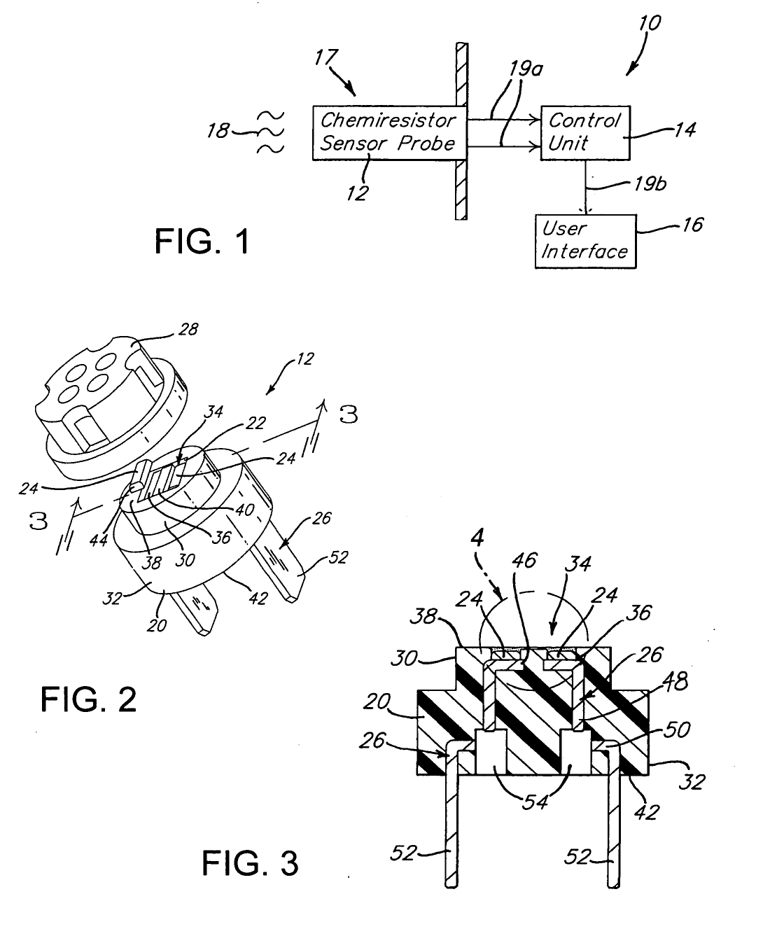

By way of background, FIG. 1 generally depicts the major components and operational principles of an exemplary chemiresistor sensor at 10. The sensor 10 is generally comprised of a chemiresistor sensor probe 12, a control unit 14, and a user interface 16. The sensor probe 12 interacts with an external environment 17 to detect the presence of analytes, or target chemical compositions 18. The sensor probe 12 generates a raw output signal 19a based on continuous detection of analytes 18 in the external environment 17. The raw output signal 19a is processed by the control unit 14. The control unit 14 transmits a calculated output signal 19b to the user interface 16 to relay analysis of the raw output signal 19a from the sensor probe 12. The user interface 16 provides information to an external user about the sensor 10 and may range from a simple alarm signal to a complex computerized screen.

Referring generally to FIG. 2, an example of a polymer-absorption chemiresistor sensor probe 12 compatible with the sensor film compositions of the teachings of the present disclosure is shown. The sensor probe 12 generally comprises a sensor housing 20, a conductive sensor film 22 covering a portion of the sensor housing 20 (FIGS. 2 and 3), a pair of electrodes 24 optionally disposed beneath and attached to the sensor terminals 26, and a protective cap 28. In lieu of electrodes, an alternate sensor embodiment is feasible, where the terminals 26 protrude into the sensor film 22, and serve a similar function to the electrodes 24 (i.e., deliver current through the sensor film 22).

The sensor housing 20 includes a first diameter portion 30 and a second diameter portion 32, wherein the first diameter portion is smaller in diameter than the second diameter portion. The first diameter portion 30 includes a sensing region 34. The sensing region 34 is comprised of two apertures 36 located within a first control surface 38 of the sensing region 34. Between the apertures 36 is a recessed second control surface 40 that extends across the sensing region 34. The second control surface 40 is slightly recessed below the first control surface 38.

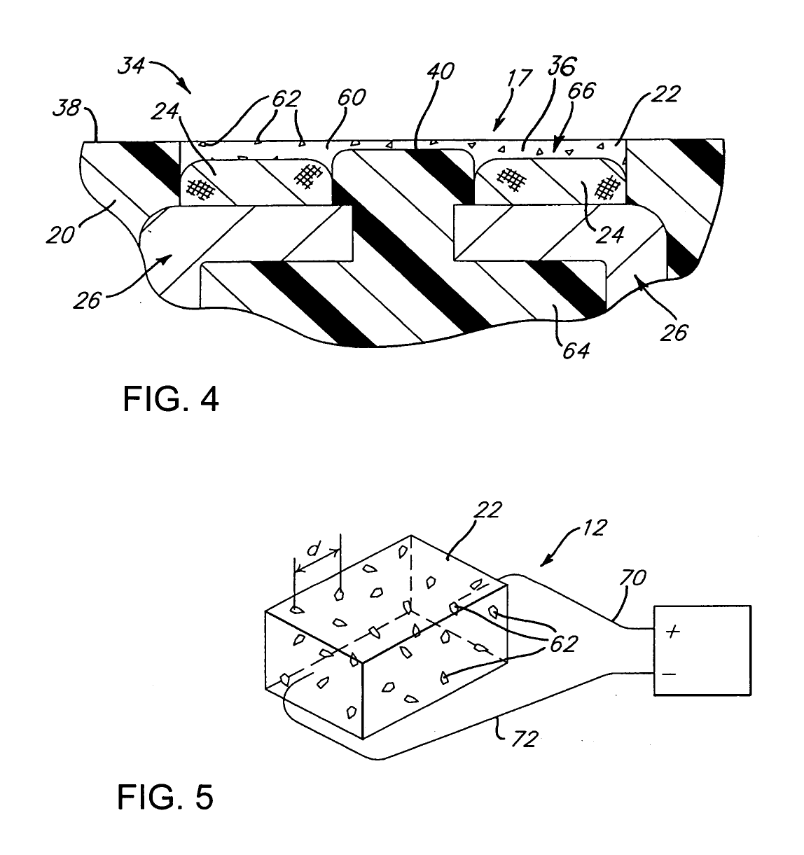

As best shown in FIG. 3, a cross-sectional view along line 3-3 of FIG. 2, each electrode 24 sits above the apertures 36. Terminals 26 are attached to the electrodes 24 and extend through both the first diameter portion 30 and the second diameter portion 32. The terminals 26 protrude from the housing 20 at an underside 42 of the second diameter portion 32. The electrodes 24 and terminals 26 are made of a conductive material, preferably a metal. With specific reference to FIG. 4, the electrodes 24 each comprise a horizontal porous plate or mesh that is parallel to the first control surface 38 and approximately equals the width of the aperture 36. Each electrode 24 is connected to establish a conductive pathway to terminal 26. With renewed reference to FIGS. 2 and 3, a first horizontal portion 46 of the terminal 26 makes either direct or indirect contact with the portion of the sensor film 22 seated within the apertures 36 to detect changes in the resistance of the sensor film 22. Extending from the first horizontal portion 46 is a first vertical portion 48. The first vertical portion 48 extends through the first diameter portion 30 and into the second diameter portion 32 where the first vertical portion 48 transitions to an inner terminal dogleg 50 that ends in the external terminals 52 (i.e., end leads).

At the transition point between the first vertical portion 48 to the inner terminal dogleg 50, the terminals 26 each have an aperture 54. The aperture 54 receives an alignment rod (not shown) during manufacturing to permit more precise alignment of the electrodes 24 within the housing 20. The inner terminal dogleg 50 extends to the external terminals 52 which extend from the underside 42 of the second diameter portion 32. The external terminals 52 extend from the housing 20 to a suitable length to permit interconnecting the leads to a corresponding outlet (not shown) of a suitable alert device, such as an alarm.

As best seen in FIG. 4, a detailed view of the sensing region 34 from FIGS. 2 and 3, the sensor film 22 comprises a polymer 60 with a plurality of conductive particles 62 dispersed throughout. The terminals 26 extend through a body 64 of the sensor probe housing 20 and are electrically connected to the electrodes 24. The electrodes 24 protrude into the sensing region 34 and into the sensor film 22. The electrodes 24 preferably are situated near the surface, and further across the sensor film, for even current distribution. A preferable configuration of the sensor film 22 includes conductive particles 62 distributed homogeneously (i.e., evenly) throughout the sensor film 22 body forming a conductive polymeric matrix 66. By “homogeneous” it is meant that the particles are substantially evenly distributed throughout the matrix, such that any potential detrimental effects resulting from uneven and/or localized charge distribution are minimized. “Matrix” refers generally to a polymer system having conductive filler particles distributed throughout within a polymer resin.

The conductive sensor film matrix 66 is seated upon the first control surface 38 such that the matrix 66 fills the apertures 36 and spans the center second control surface 40. The matrix 66 fills the apertures 36 so that the matrix 66 is in either direct or indirect electrical contact with both of the electrodes 24. Upon exposure of the matrix 66 to target analytes, the matrix 66 volume increases by swelling.

The polymer resin 60 of the sensor film 22 can be any polymer that readily absorbs a target analyte or chemical compound, through a gas-solid interface occurring between a surface of the sensor film 22 and the surrounding gas in the external environment 17 (FIG. 1) at a rate that is relatively proportional to the concentration of the analyte in the surrounding gas. Thus, a correlation can be made between the quantity of analyte absorbed, and the concentration of the analyte in the surrounding gas. In the exemplary sensor probe 12 depicted, the change in the volume of the sensor film 22 is correlated to the concentration of the analyte present in the gas and is further related to the resistance of the sensor film 22. Of particular interest are sensor films 22 that detect vaporous hydrocarbon compound analytes, such as one or more volatile organic compounds (VOCs). Compatible polymers for detecting VOCs include siloxane polymers. A variety of siloxane based polymers are contemplated in the present and disclosure, and further discussed below.

As shown in FIG. 5, the operational principle of a polymer-absorption chemiresistor sensor probe 12 involves applying a current through the sensor film 22 between a positive 70 and a negative lead 72. Preferably, the positive and negative leads 70, 72 are terminals and/or electrodes, such as those shown at 24 and 26 in FIGS. 2-4. Conductive particles 62 are distributed throughout the sensor film 22 to enhance the electrical conductivity. Resistance measurements are taken across the sensor film 22 via monitoring of the current and potential difference across the sensor film 22 between the negative and positive leads 70, 72, and typically is measured by the processing or control unit 14 (FIG. 1) attached to the sensor probe 12. Resistance values vary with the distance “d” between the conductive particles. As this distance “d” between the conductive particles 62 increases, the resistance has a proportional relationship and thus increases. If the distance “d” decreases, the resistance also decreases. Thus, any increase or decrease in the volume of the sensor film 22 affects the overall resistance measurements.

Upon detection of a change in resistance between the positive and negative leads 70,72, the user interface 16 (FIG. 1) provides a signal indicating the presence of the substance for which the sensor film 22 has an affinity. Consequently, the change in resistance of the sensor film 22 detected by the electrodes 70, 72 indicates the presence of the target analyte. The sensor film 22 volume may increase both by changes in temperature, as well as absorption of chemical compounds, or target analytes, into the polymer of the sensor film 22. One aspect of the present disclosure relates to minimizing effects of volume changes of the sensor film 22 due to temperature, and maximizing the absorption and sensor film 22 sensitivity to chemical compounds. Further, as appreciated by one of skill in the art, it is desirable to have a substantially homogenous distribution of the plurality of conductive particles 62 within the sensor film 22 to negate any potential localized variations that might occur. In certain embodiments, a base resistance is less than or equal to about 10 kOhms. In various embodiments, a sensor film 22 has a base resistance of less than or equal to about 5 kOhms, optionally less than or equal to about 3 kOhms. The base resistance is preferably obtained by measuring the resistance at time 0 and at room temperature and pressure (e.g., 21-26° C. and 1 atm psia) before exposure to analytes.

Further, the long-term stability and maintenance of particle distribution is important to the accuracy of the device for long-term use. Potential phase separation and migration of the particles through the matrix can cause spatial variations of the conductive particles across the sensor film that can impact the capability of the sensor film to accurately measure the presence of the target analyte compounds. Long-term accuracy is a crucial parameter for sensor operation. Further, in some embodiments of the present disclosure, the sensor is suitable for use in a low-current application. An enhanced conductivity of the plurality of conductive particles can contribute to a reduction in the amount of current that must be applied, and hence improved conductivity permits certain embodiments of the present disclosure to be used as low resistance sensors in low current/low resistance applications.

By “low resistance” it is meant that a base resistance of the sensor (in the absence of target analytes at ambient conditions) exhibited by the sensor film matrix is less than about 100 kOhms, more preferably less than about 30 kOhms, even more preferably less than about 10 kOhms, preferably less than or equal to about 5 kOhms, optionally less than or equal to about 3 kOhms, and optionally less than about 1 kOhm. In some embodiments, the low resistance sensor has a resistance of less than about 100 Ohms. For very low current applications, such as those which operate remotely with a mobile power source, for example, a battery, it is preferable that the base resistance of the sensor is less than about 5 Ohms, more preferably less than about 1 Ohm, and even more preferably less than about 50 mOhms, optionally less than about 10 mOhms. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

Further, it is preferable that sensor films have efficient and improved sensitivity to one or more target analytes, while minimizing cross-sensitivity to temperature (many chemiresistor films exhibit increased resistance upon exposure to an increase in temperature, independent of the concentration of the analyte). Such functions of the sensor can be expressed by overall resistance, as well as a “Vapor Ratio” and a “Temperature Ratio”, which will be described in more detail below.

Thus, in various embodiments, the present disclosure provides a polymer matrix having a plurality of conductive particles. The conductive particles preferably have one or more polymers bonded or “grafted” to the surface of the conductive particle. The polymer-grafted conductive particles thus have polymer chains that extend from the surface of the conductive particle. While not wishing to be bound by any particular theory, it is believed that the polymer chains enhance long-term stability of the particles, as they appear to minimize widespread migration of the particles within the matrix over time as compared to non-polymer grafted conductive particles. It is believed that the polymer-grafted conductive particles are more anchored within the polymer matrix by virtue of the polymer ligands extending from the surface of the particle and the interaction of the polymer chains with the polymer resin. The stability of the polymer-grafted conductive particles maintains the homogeneous distribution of the particles in the matrix and improves robustness and long-term durability by eliminating any potential global movement of the particles in the matrix. Additionally, certain conductive particles can have highly hydrophobic surfaces that can pose difficulty in dispersing the particles within certain polymer resins, as they such particles tend to be incompatible with certain resins and potentially agglomerate. The introduction of the polymer chains to the surface of such hydrophobic conductive particles (e.g., carbon black) appears to facilitate easier dispersion within a polymer matrix and minimizes potential phase separation.

Conductive particles suitable for grafting with polymers according to various embodiments of the present disclosure can include any particle, powder, granule, fiber, whisker, tube, or other conductive bodies of any shape and relatively small size (preferably less than about 150 μm). The surface of the conductive particle should be capable of reacting with the polymer chain during the grafting process. As described below, in some circumstances, the surface of the conductive particle is activated and preferably has one or more types of functional groups present. In certain embodiments, the conductive particle comprises carbon or graphite. In certain embodiments, the conductive particle is carbon black.

Another benefit of the polymer-grafted conductive particles used in various embodiments of the present disclosure is the improved sensitivity to one or more target analytes, as well as conductivity and reduced resistance. Such polymer-grafted conductive particles reduce the cross-sensitivity to temperature fluctuations, as well. Any suitable polymer-grafted conductive particles are contemplated by the present disclosure.

By way of background, the grafting or bonding of a polymer to a substrate is well-known in the art. Typically, the surface of the conductive particle has one or more functional groups that are capable of reacting with a functional group on a polymer. As such, the functional group on the surface of the polymer moiety and the functional group on the polymer react to form a covalent bond. The bond between the conductive surface and the polymer chain can be, for example, an ester, thioester, amide, amino, ether, thioether, carbonyl, thiocarbonyl, and/or sulfonyl, as are well recognized by one of skill in the art.

In certain embodiments, the polymer that is grafted onto the surface of the conductive particle is a non-conductive polymer. Non-limiting examples of suitable polymers include polyethylene, polyurethane, and polydimethylsiloxane. As is recognized by one of skill in the art, any suitable polymer can be used, where the polymer is capable of having a functional group that reacts with the conductive particle. Further, various embodiments of the present disclosure contemplate co-polymers or terpolymers, where distinct monomers are incorporated into the polymer chain that is then grafted to the conductive particle. In one embodiment, the polymer-grafted conductive particle is a polyethylene grafted conductive particle. More specifically, in certain embodiments, the polymer-grafted conductive particle is a polyethylene (PE) carbon black.

In certain embodiments, the polymer that is grafted onto the surface of the conductive particle is an electrically conductive polymer. Such electrically conductive polymers include those well known by one of skill in the art, and include, by way of example, polyaniline, polypyrrole, polythiophene, and mixtures thereof. It should be noted that the grafting of the electrically conductive polymer can be performed in a different manner to that described above. For example, electropolymerization can be used to form the electroconductive polymer chains on the surface of the conductive particle. In one example, a solution can be formed from acrylonitrile in an aprotic solvent (e.g., acetonitrile) in the presence of an electrolyte (e.g., C₂H₅NClO₄) and the conductive particles are contacted with the solution and electrolysis is conducted to form chains of polyacrylonitrile on the surface of the conductive particles. In certain embodiments of the present disclosure, a preferred electroconductive polymer for the polymer-grafted conductive particle comprises Polyaniline. In one embodiment, the polymer-grafted conductive particle is a Polyaniline (PANI) carbon black. One such PANI coated carbon black is commercially available from Sigma-Aldrich Co. of St. Louis, Mo. as Product 530565 Polyaniline (emeraldine salt) carbon black, which is a carbon black having 20 wt %. loading of polyaniline that has a bulk electrical conductivity of about 40 S/cm.

In certain embodiments, the polymer-grafted conductive particle has an axial geometry, and includes fibers, wires, whiskers, filaments, tubes, and the like. Such particles having a cylindrical or rod shape with an elongated axis have an axial geometry. Generally, an aspect ratio (AR) for cylindrical shapes (e.g., a rod or fiber) is defined as AR=L/D where L is the length of the longest axis and D is the diameter of the cylinder or fiber. Exemplary axial geometry particles suitable for use in the present disclosure generally have high aspect ratios, ranging from about 500 to about 5,000, for example, where an average diameter of the particle ranges from less than 1 nm to about 30 nm, and the length of the nanoparticle can be from several hundred nanometers to greater than about 10 μm. Axial geometry conductive particles include carbon nanotubes, where exhibit excellent electrical conductivity, for example, 100 S/cm. In certain embodiments, the conductive particle is a carbon nanotube (either multi-walled or single-walled) grafted with an electroconductive polymer. One such example is a polypyrrole-grafted carbon nanotube. In embodiments where the polymer of the grafted carbon black is selected to be an electroconductive polymer, the resistance exhibited by the polymer matrix in the sensor is particularly low. For example, in some embodiments, the maximum resistance exhibited is less than about 5 kOhms, in some embodiments less than about 4 kOhms, in some embodiments less than about 3 kOhms, in some embodiments less than about 2 kOhms, and in some embodiments less than about 1 kOhm.

As appreciated by one of skill in the art, the matrix can comprise two or more distinct species of conductive particles to enhance sensor operations. Thus, the plurality of conductive particles may contain multiple distinct species of conductive particles, creating various blends of conductive particles. For example, a first polymer-grafted conductive particle and a second polymer-grafted conductive particle can be distributed in the matrix. Further, a first species of conductive particle can comprise a polymer-grafted conductive particle, as where a second species of conductive particle comprises a conventional conductive particle. Any number of combinations of species of conductive particles is contemplated by the present disclosure, so long as at least one of the conductive particles is a polymer-grafted conductive particle.

In accordance with certain embodiments of the present disclosure, in addition to the polymer-grafted conductive particles, the matrix further comprises at least one other species of conductive particles. One particularly efficacious conductive particle is a carbon black material that has a relatively low surface area values and DBP absorption values, in essence, conductive particles that are larger in particle size and lower in aggregate size. Carbon black particles may be characterized by particle size, surface area per weight, and structure. A correlation generally exists between surface area and particle size, where a smaller particle diameter gives rise to a higher surface area. Likewise, a lower surface area value generally indicates a larger particle size diameter. Surface area is generally tested by the level of nitrogen adsorption (N₂) values in m²/g. Testing procedures for nitrogen adsorption are outlined for example, in ASTM test D3037-91. Conductive carbon black particles for use as one species in accordance with the present disclosure preferably have a N₂ adsorption value (surface area per weight) of between about 8 to about 25 m²/g. The most preferred ranges of N₂ adsorption for these carbon black species are between about 10 to about 15 m²/g.

Conductive carbon black particles are characterized by structure, or the configuration, of individual particles forming an aggregate. Structure can be tested by oil dibutylphthalate (DBP) absorption in accordance with test procedure ASTM D2414, where DBP is added to 100 grams of carbon black while being mixed to generate a value of DBP ml/100 grams. A sharp increase in the torque determines the DBP value. This test indicates the structure of the particles by measuring the size of the particle aggregate. When one of the species of the plurality of conductive particles is selected to be carbon black, the DBP preferably ranges from about 1 to about 180 ml/100 g.

Carbon blacks can be formed by a variety of processing conditions, and the method of formation often relates to the physical parameters of the carbon black. Two main forms of carbon black are thermal black, formed by thermal decomposition, or cracking, of natural gas. Furnace blacks are formed in an incomplete combustion furnace process, which typically entails burning or oxidizing of a carbon rich oil-based feedstock at high temperatures. Furnace blacks generally have a small particle size, as where thermal blacks tend to have the largest particle sizes of carbon blacks. Fine thermal blacks typically have an average particle size in the range of about 100 to 200 nm, and fall into the class of carbon blacks designated N800 series. One particularly preferred fine thermal black is the class N880, which varies in average particle size, but is generally between about 90 to about 120 nm. Examples of commercially available conductive carbon black particles that fulfill the preferred physical characteristic ranges for one of species of conductive particles as described above include: Asahi 15HS or AS N880, both manufactured by Asahi Carbon Co., Ltd. of Japan; or CC N880 from Cancarb Ltd. of Alberta, Canada; and Spheron® 5000 or Spheron® 6000 both available from the Cabot Corporation of Boston, Mass. Preferred ranges of the mean particle size are from about 90 to about 400 nanometers, preferably less than 200 nm, and most preferably less than about 150 nm. One particularly preferred large particle size carbon black is the Asahi 15HS, which has an average particle size of between about 100 to about 130 nm, an N₂ adsorption of about 14 m²/g, a DBP of about 85 ml/100 g, and a density of about 1.8 g/cc. It should be noted that such conductive carbon black particles may also be grafted with polymer, as described above, to form the polymer-grafted conductive particles or can be used in combination with other polymer-grafted conductive particles.

In certain embodiments, in addition to the polymer-grafted conductive particle, the matrix comprises an electrically conductive metal particle. Selection of the conductive metal particles is highly dependent on physical similarity to the other species of conductive particle present in the matrix. Examples of such electrically conductive metals include nickel, gold, silver, manganese, copper, iron, cobalt, magnesium, aluminum, mixtures and alloys thereof. Particularly preferred electrically conductive metal particles include gold, silver, and nickel.

Other exemplary suitable conductive particles that can be used with the present disclosure, as recognized by one of skill in the art, include, for example, platinum, graphite (i.e., hexagonally crystallized carbon), other carbon blacks not described above, conductive metal borides, nitrides or carbides. Further, the total amount of the plurality of conductive particles added is dependent on the individual characteristics of the particle selected, but can range from about 25 to about 75 percent by weight of the total mixture. In certain embodiments, the polymer-grafted carbon black is present at about 5 to about 30 parts per hundred resin (phr).

Distribution of the conductive particles 62 throughout the polymer base 60 can be achieved by mixing the conductive particles 62 into a polymer mixture prior to application on the sensor probe 12 to form a matrix mixture which forms the polymer base 60 of the sensor film 22. Preferably, the conductive particles 62 are homogeneously distributed throughout the polymer matrix base 60 to enhance the uniformity of resistance measurements, as discussed above. The use of the polymer-grafted conductive particles 62 in chemiresistor sensor films 22, significantly enhances the sensitivity of the sensor film 22 to chemical analytes over the prior art use of conductive particles. Further, there is a significant decrease in temperature cross-sensitivity.

In various embodiments of the present disclosure, the sensor film 22 comprises a polymer resin. In various embodiments, the polymer comprises siloxane. A “siloxane polymer” as used herein, refers to a cross-linked polymer that has a basic backbone of silicon and oxygen with side constituent groups that may be the same or different, generally described by the structural repeating unit (—O—SiRR′—)ₙ, where R and R′ may be the same or different side constituent groups, and n may be any value above 2 designating the repetition of the SRU in the polymer backbone. Thus, such siloxane polymers generally comprise at least one siloxane monomer or SRU. Siloxane polymers are also known in the art as “silicone” polymers. Siloxane polymers may include polyheterosiloxanes, where side groups and/or structural repeating units may be different entities (having different side constituent groups), such as, for example, the siloxane co-polymer described by the nominal SRU formula, (—O—SiRR′)ₙ—(—O—Si—R″R′″)ₘ, wherein R and R′ are distinct side groups from R″ and R′″. Further R and R′ may be different from one another, likewise the same may be true for R″ and R′″. Such siloxane polymers may terminate in any variety of terminal groups, such as for example, trimethyl silyl ((CH₃)₃Si) terminated siloxane, or ethyl vinyl terminated siloxane.

In one embodiment of the present disclosure, the polymer of the sensor film is a cross-linked dimethylsiloxane (—O—SiRR′)ₙ, where R and R′ are both CH₃. Such side groups may be referred to as “branched” indicating side groups attached to the siloxane backbone.

In an embodiment of the present disclosure, the sensor film 22 comprises a crosslinked siloxane polymer base, wherein the siloxane polymer backbone has at least one monomer with a large hydrocarbon substituted side group represented by R′ in the nominal general formula for the structural repeating unit (—O—SiRR′)ₙ. A “hydrocarbon side group”, as used herein, includes any hydrocarbon or hydrocarbon derived side group with two carbon atoms or greater. Examples of such hydrocarbon side groups include: alkyl and aryl groups greater than an ethyl group, branched alkyl groups, aromatics, modified hydrocarbon compounds comprising a polar groups, or mixtures thereof. Polar group modified hydrocarbons incorporate a polar molecule or molecular group into the hydrocarbon side group structure, with the effect of imparting polarity on the entire side group. Such polar atoms or groups may include, for example, oxygen, nitrogen, or ammonia, cyano or hydroxyl groups. Examples of preferred hydrocarbon side groups include without limitation: ethyl, propyl, butyl, pentyl, hexyl, heptyl, octyl, nonyl, decyl, phenyl, alkylphenyl, cyclopentyl, and phenylpropyl. Particularly preferred hydrocarbon side groups are alkyl groups with eight or more carbon atoms (octyl groups or higher). Other preferred hydrocarbon side groups comprising a polar group include, for example, butylated aryloxypropyl, N-pyrrolidonepropyl, cyanopropyl, benzyltrimethyl ammonium chloride and hydroxyalkyl.

One example of such a siloxane having a large hydrocarbon side group includes an octyl hydrocarbon side group that forms an octylmethylsiloxane monomer. It is preferable that the siloxane polymer according to the present embodiment is crosslinked, and thus also contains a functional group capable of crosslinking during any subsequent curing or crosslinking processes. Preferred crosslinked siloxane polymers include those polymers (including homopolymers and copolymers) having at least one large hydrocarbon side substituent group. As used herein, the term “polymer” encompasses homopolymers and copolymers. The term “copolymer” generically refers to a polymeric structure that has two or more monomers polymerized with one another, and includes polymers such as terpolymers with three combined monomers. A “homopolymer” refers to a polymer formed of a single repeating monomer. One example of a preferred crosslinked siloxane having a copolymer (e.g., terpolymer) structure is poly(vinylmethylsiloxane-octylmethylsiloxane-dimethylsiloxane). Thus, the terpolymer structure has vinyl functional groups that are capable of crosslinking when exposed to crosslinking or curing agents. Ranges of the quantity of monomers in the terpolymer include (3-5% vinylmethylsiloxane)-(35-75% octylmethysiloxane)-(20%-62% dimethylsiloxane), wherein the octyl is the hydrocarbon side group, R′, incorporated into the siloxane monomer, and R is a methyl side group. Another example of a preferred crosslinked siloxane having a large hydrocarbon side group according to the present disclosure is a polyphenylmethylsiloxane, where the phenyl is the large hydrocarbon side group and the polymer has vinyl terminal groups for subsequent crosslinking.

In certain embodiments, the terpolymer having a large hydrocarbon side group is further reacted with another polymer. Preferably, this additional polymer likewise comprises siloxane, and may be a homopolymer or copolymer, as described above, with functional groups capable of crosslinking. Thus, in a certain embodiment of the present disclosure, the additional copolymer comprises a polydimethyl siloxane. In another embodiment, the additional copolymer comprises a siloxane copolymer further comprising an additional large hydrocarbon side group. For example, one suitable polymer comprises (7-13% hydroxymethylsiloxane)-(87-93% octylrmethylsiloxane), has an average molecular weight of about 6000, and is capable of cross-linking with the first copolymer described above.

Incorporation of large hydrocarbon side groups into monomers (which are further incorporated into polymers according to the present disclosure) is achieved by polymerization performed in a conventional manner. Such a monomer, having a side group, is preferably functionalized by incorporating a reactive functional group (e.g., epoxy, amine, mercapto, methacrylate/acrylate, acetoxy, chlorine; hydride or vinyl; or hydroxyl groups) to facilitate incorporation into the siloxane backbone by polymerization, such as by conventional methods known in the art. In the case of poly(vinylmethylsiloxane-octylmethylsiloxane-dimethylsiloxane), discussed above, the octylmethylsiloxane monomer is incorporated into a copolymer with other monomers of dimethylsiloxane and vinylmethyl siloxane, where the octylmethylsiloxane monomer is preferably present in the range of from about 35% to about 75%. The octylmethylsiloxane monomer displaces the dimethylsiloxane monomer. In the case of polyphenylmethylsiloxane, substantially all of the polymer chain comprises the phenylmethylsiloxane monomer, except for the terminal ends of the siloxane polymer which are vinyl terminated (e.g., dimethylvinyl terminated siloxane). Such monomer ranges are exemplary and non-limiting and are dependent upon specific characteristics of the individual monomers employed. It is preferable to maximize the quantity of large hydrocarbon side group substituted monomers in the siloxane polymer, because maximizing the amount of large hydrocarbon side groups in a siloxane based polymer sensor film has been shown to increase the overall temperature stability and analyte sensitivity.

After the large hydrocarbon side group siloxane base copolymer (or plurality of distinct copolymers) is formed (by a conventional polymerization reaction), the polymer(s) further undergo cross-linking after incorporation into the sensor film. Such crosslinking may be carried out by conventional means, such as by exposure to irradiation or peroxide, moisture cure by a condensation reaction, or a hydrosilylation reaction in the presence of a catalyst. Any method of crosslinking siloxane polymers may be used with the present disclosure, as recognized by one of skill in the art. A preferred method of crosslinking is the hydrosilylation reaction in the presence of a catalyst, which can generally be conducted at lower temperatures and where the control over the degree of crosslinking is greater.

Crosslinking by hydrosilylation generally requires a catalyst and a crosslinking (curing) reagent which reacts with accessible functional groups on at least some of the side groups within the siloxane polymer. One example of a hydrosilylation crosslinking reaction includes, for example, polyethylhydrosiloxane as a crosslinking reagent in the presence of a platinum catalyst to result in a crosslinked siloxane polymer. Polyethylhydrosiloxane is commercially available as the product HES-992, from Gelest, Inc. of Tullytown, Pa. The hydrosilylation reaction facilitates crosslinking between neighboring siloxane chains at the functional group sites. Other feasible catalyst systems that may be used for hydrosilylation (in addition to platinum) in the present disclosure include, for example: platinum carbonyl cyclovinylmethyliloxane complex used for elevated cures, such as SIP 6829 which is also commercially available from Gelest, Inc.; Rh(I) catalysts such as (PPh₃)₃RhCl or [(C₂H₄)₂RhCl]₂, Ni catalysts, (PPh₃)PdCl₂, Rh₂(OAc)₄, Ru₃(CO)₁₂, and Co₂(CO)₈ and equivalents thereof. Functional groups must be present along the siloxane backbone or at the chain ends to allow for subsequent crosslinking after polymerization. The distinct monomers within any of the copolymers may be distributed randomly or may be regularly ordered.

The crosslinking reaction is preferably achieved through a hydrosilylation reaction by adding an appropriate curing reagent and a catalyst. The rate of reaction for crosslinking is dependent on temperature and is accelerated when temperature is raised; a catalyst is added; or both. Temperature may be used to control the rate of reaction to coincide with processing needs. Further, the addition of the catalyst may be prolonged until the mixture is ready to be processed for application onto the sensor. Preferably, the curing reagent is added in the range of about 1 to about 5 weight % of the total polymer and curing reagent to form a polymer mixture. Preferably, catalyst is charged to the polymer mixture from about 0.05 to 1 weight percent of the total polymer mixture (excluding conductive particles).

A matrix mixture may be formed by admixing the plurality of conductive particles into the polymer resin (where there is more than a single species, the conductive particles are pre-mixed prior to charging with the catalyst). The plurality of conductive particles are added in a range of from about 25 to about 75% of the total mixture depending on particle characteristics, including tendency to disperse in the matrix. It is preferred that the plurality of conductive particles is well mixed into the polymer mixture for even distribution. The polymer or matrix mixture can be blended or mixed by equipment known in the art, such as for example, a mixer (e.g., a Banbury® or Brabender® mixer), a kneader, a monoaxial or biaxial extruder (e.g., single-screw or twin-screw extruders).

The handling and flowability of a matrix mixture is dependent on the rate of crosslinking once the catalyst is added, which affects the viscosity of the mixture. The amount of time that remains for handling is generally known as the “pot life”, and may range from many hours at room temperature to less than an hour if temperatures are raised to above room temperature. The crosslinking or curing reaction may be prolonged by addition of inhibitors, which are well known in the art, as a means for retarding the reaction. The crosslinking or curing reaction can be performed entirely at room temperature, or may be accelerated by heating the mixture, depending on the processing needs. Such curing temperatures range from about 30° C. to about 250° C. The mixture is then applied to the sensor surface by conventional application means (e.g., doctor blade, casting, lamination, extrusion, pad printing, spraying or silk screening). After application, further sensor components and processing may be completed, such as applying a protective cap. Curing occurs by any conventional methods known in the art, for example, by placing the sensor having an applied matrix mixture applied into an oven at elevated temperature, for example, for 3 to 8 hours at 120° C. to 130° C. However, many variations of curing the siloxane polymer in the matrix mixture are feasible with the present disclosure.

Testing of such sensor films 22 according to the various embodiments of the present disclosure have demonstrated both increased temperature stability and analyte sensitivity, as well as reduced resistance when compared with known chemiresistor sensor films.

### EXAMPLE 1

A sensor film polymer matrix having a blend of conductive particles including a polyaniline (PANI) grafted carbon black conductive particle and a large particle size conductive carbon black is prepared by adding the following materials into a mixer: 3.0 grams polymer 96.9 parts by weight VAT-4326 a (3-5% vinylmethylsiloxane)-(35-40% octylmethylsiloxane)-(dimethylsiloxane) terpolymer available from Gelest; 3.1 parts by weight a copolymer of (7-13% hydroxymethylsiloxane)-(87-93% octylmethylsiloxane); 19.5 grams of conductive particle blend including 6 parts per hundred resin (phr) polyaniline grafted carbon black available from Aldrich and 144 phr Asahi 15HS (a large particle size carbon black available from Asahi Carbon Company having an N₂ value of 14 m²/g and a DBP of 85 ml/100 g); 0.1 grams of SIP 6829 (a platinum carbonyl cyclovinylmethylsiloxane catalyst complex). The materials are mixed in a Brabender® mixer for 15 minutes at 30° C. and 80 rpm to form a matrix mixture. The mixture is then applied in a groove over electrodes in a sensor structure. The sensor structure having the matrix mixture applied is then cured for 8 hours at 130° C.

### EXAMPLE 2

Example 2 is prepared in a similar manner to Example 1, however the sensor film matrix has a higher concentration of PANI grafted carbon black particles. The following materials are added into a mixer: 3.0 grams 96.9 parts by weight VAT-4326 a (3-5% vinylmethylsiloxane)-(35-40% octylmethylsiloxane)-(dimethylsiloxane) terpolymer available from Gelest; 3.1 parts by weight a copolymer of (7-13% hydroxymethylsiloxane)-(87-93% octylmethylsiloxane); 19.7 grams of a conductive particle blend that includes 10 parts per hundred resin (phr) polyaniline grafted carbon black available from Aldrich and 144 phr Asahi 15HS (a large particle size carbon black available from Asahi Carbon Company having an N₂ value of 14 m²/g and a DBP of 85 ml/100 g); 0.1 grams of SIP 6829 (a platinum carbonyl cyclovinylmethylsiloxane catalyst complex). The materials are mixed in a Brabender® mixer for 15 minutes at 30° C. and 80 rpm to form a matrix mixture. The mixture is then applied in a groove over electrodes in a sensor structure. The sensor structure having the matrix mixture applied is then cured for 8 hours at 130° C.

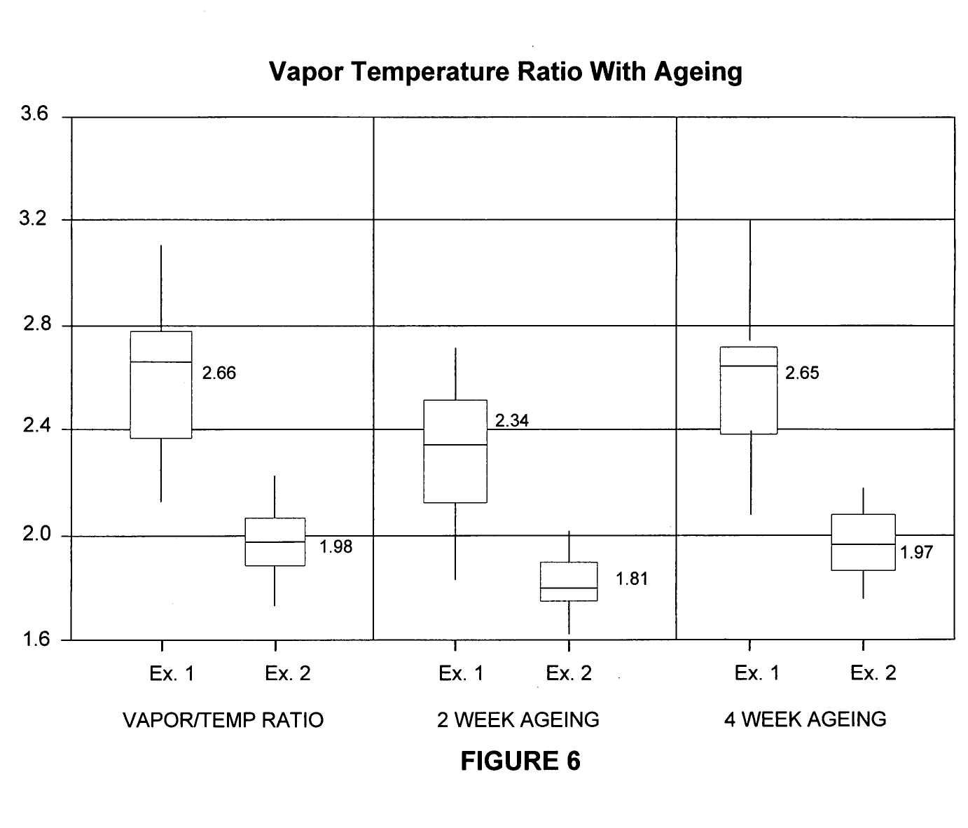

In FIG. 6, experimental data charts the resistance as represented by vapor temperature ratios for Examples 1 and 2 for a time range spanning from 0 to 4 weeks. The Vapor Ratio is calculated by taking the measurement of the resistance of the sensor film upon exposure to a target analyte at 0 seconds and 20 seconds, and dividing the 20 second resistance value by the 0 second value. Preferably, the vapor ratio is maximized as much as possible. Thus, it is preferred that the vapor ratio is greater than about 10, more preferably greater than about 20. For establishing the temperature ratio, the resistance is measured at a first temperature of 25° C. and a second temperature of 65° C., where the temperature ratio is the resistance value at 65° C. divided by the resistance value at 25° C. Ideally, the temperature ratio approaches zero to reflect no variations in resistance which are attributed to changes in temperature. Practically, it is preferred that the temperature ratio is less than about 5, more preferably less than about 3. Further, to obtain a Vapor to Temperature Ratio, the respective vapor ratio is divided by the respective temperature ratio, and the resulting Vapor to Temperature ratio can be used for comparison purposes to evaluate the performance of the sensor over time.

The resistance values of the sensor films of Examples 1 and 2 were tested by exposure to 1.8% cyclohexane at 50% lower flammability limit at different times and temperatures, as described above. Thirty sensor probes having the polymer matrix prepared in accordance with either Example 1 or Example 2 were tested to generate the data in FIG. 6. As previously described above, maintaining the vapor to temperature ratio over time demonstrates the robustness and long-term stability of the sensor film matrix. As can be observed in FIG. 6, the initial vapor to temperature ratio at time=0 (shortly after preparation of the sample probes) for Example 1 was about 2.66 and for Example 2 was about 1.98. After two weeks, Example 1 had a ratio of 2.34 and Example 2 had a ratio of 1.81. After 4 weeks, Example 1 had a ratio of about 2.65 and Example 2 had a ratio of about 1.97. These ratios remained within a small range and did not show any significant deviations with aging.

Thus, the sensor films prepared in accordance with Examples 1 and 2 demonstrate not only significant reductions in the resistance of the sensor film matrix, but also provide robustness and stability over time, in addition to maximizing the vapor ratio and minimizing the temperature ratio which is desirable for sensor film design.

The sensor films according to the various embodiments of the present disclosure provide a robust low resistance sensor having good stability during temperature fluctuations, thus ensuring the accuracy of the sensor readings of analyte concentration by making it less dependent on variations in temperature. Thus, the fundamental trade-off between temperature sensitivity (swelling) and sensitivity to analytes has been improved. The present disclosure provides increased sensitivity to target analytes over the prior art sensor films, improving the sensor film operation. Further, the sensors have increased energy efficiency and robustness, and can be used in low current/resistance applications. The description and examples provided herein are merely exemplary in nature and, thus, variations that do not depart from the gist of the disclosure are intended to be within the scope of the disclosure. Such variations are not to be regarded as a departure from the spirit and scope of the disclosure.

What is claimed is:

1. A conductometric sensor film for detecting one or more chemical analytes comprising:
a polymer matrix comprising a crosslinked polymer and a plurality of particles including a plurality of polymer-grafted conductive particles homogeneously distributed within said matrix; and
wherein the sensor film exhibits a change in resistance in the presence of the one or more chemical analytes.

2. The sensor film according to claim 1 wherein said polymer-grafted conductive particles comprise carbon.

3. The sensor film according to claim 1 wherein said polymer of said polymer-grafted conductive particles is an electrically conductive polymer.

4. The sensor film according to claim 3 wherein said electrically conductive polymer is selected from the group consisting of: polyaniline, polypyrrole, polythiophene, and mixtures thereof.

5. The sensor film according to claim 1 wherein said polymer of said polymer-grafted conductive particle is selected from the group consisting of: polyethylene, polyurethane, polydimethylsiloxane, and mixtures thereof.

6. The sensor film according to claim 1 wherein said plurality of polymer-grafted conductive particles comprises a polyethylene grafted carbon black.

7. The sensor film according to claim 1 wherein said plurality of polymer-grafted conductive particles comprises a polyaniline grafted carbon black.

8. The sensor film according to claim 1 wherein said conductive particle of said polymer-grafted conductive particles comprises a carbon nanotube.

9. The sensor film according to claim 1 wherein said plurality of particles further comprises conductive carbon black particles having an N₂ adsorption of between about 8 to about 25 m²/g and a DBP of about 1 to about 180 ml/100 g.

10. The sensor film according to claim 1 wherein the sensor film is a low resistance sensor film and said base resistance is less than or equal to about 5 kOhms at room temperature.

11. The sensor film according to claim 1 wherein said cross-linked polymer comprises a siloxane monomer having at least one hydrocarbon side group with greater than or equal to two carbon atoms.

12. The sensor film according to claim 1 wherein said crosslinked polymer comprises an octylmethylsiloxane monomer.

13. A low resistance conductometric sensor film for detecting one or more chemical analytes comprising:
a polymer matrix comprising a crosslinked polymer comprising a siloxane monomer and a plurality of particles including a plurality of polymer-grafted conductive carbon black particles homogeneously distributed within said matrix; and
wherein the sensor film exhibits a base resistance that is less than or equal to about 5 kOhms at room temperature.

14. The sensor film according to claim 13 wherein said polymer of said polymer-grafted conductive particles is an electrically conductive polymer.

15. The sensor film according to claim 13 wherein said electrically conductive polymer is selected from the group consisting of: polyaniline, polypyrrole, polythiophene, and mixtures thereof.

16. The sensor film according to claim 13 wherein said polymer of said polymer-grafted conductive particle is selected from the group consisting of: polyethylene, polyurethane, polydimethylsiloxane, and mixtures thereof.

17. The sensor film according to claim 13 wherein said polymer matrix further comprises conductive carbon black particles having an N₂ adsorption of between about 8 to about 25 m²/g and a DBP of about 1 to about 180 ml/100 g.

18. The sensor film according to claim 13 wherein said cross-linked polymer comprises a siloxane monomer having at least one hydrocarbon side group with greater than or equal to two carbon atoms.

19. The sensor film according to claim 13 wherein said crosslinked polymer comprises an octylmethylsiloxane monomer.

20. A low resistance conductometric sensor film for detecting one or more chemical analytes comprising:
a polymer matrix comprising a crosslinked polymer comprising siloxane and a plurality of polymer-grafted conductive carbon black particles homogeneously distributed within said matrix, wherein said polymer of said polymer-grafted conductive carbon black particles is electrically conductive and selected from the group consisting of: polyaniline, polypyrrole, polythiophene, and mixtures thereof.
